(19) United States
(12) Patent Application Publication
(10) Pub. No.: US 2024/0025464 A1
(43) Pub. Date: Jan. 25, 2024

(54) TILTING SHELF SYSTEM FOR CARTS

(71) Applicant: Pipp Mobile Storage Systems, Inc., Walker, MI (US)

(72) Inventors: Matthew M. Long, Lakemoor, IL (US); Brian McDonald, Lisle, IL (US)

(21) Appl. No.: 18/357,736

(22) Filed: Jul. 24, 2023

Related U.S. Application Data
(60) Provisional application No. 63/391,770, filed on Jul. 24, 2022.

(51) Int. Cl. B62B 3/02; A47B 57/04; B62B 3/00

(52) U.S. Cl. CPC B62B 3/02; A47B 57/04; B62B 3/005

(57) ABSTRACT

A tilting shelf system for a mobile support includes a shelf pivotably coupled to the mobile support. A handle coupled to the shelf may be actuated by a user between locked and unlocked positions to urge a securing member between secured and unsecured positions. While the securing member is in the unsecured position, the shelf is rotatable relative to the mobile support to be adjusted into a desired tilted or angled orientation. Once in the desired orientation, the user may actuate or release the handle to urge the securing member into the securing position, thus fixing the orientation of the shelf relative to the mobile support. A biasing member coupled to the shelf and attachable to the mobile support, produces a biasing force to aid in moving the shelf as the biasing member extends and retracts in response to movement of the shelf relative to the mobile support.

### CROSS REFERENCE TO RELATED APPLICATION

The present application claims the benefit of U.S. provisional application Ser. No. 63/391,770, filed on Jul. 24, 2022, which is hereby incorporated herein by reference in its entirety.

### FIELD OF THE INVENTION

The present invention relates to a shelf for support structures, carts, and the like.

### BACKGROUND OF THE INVENTION

Various support structures, such as a cart or other mobile support structure, may include shelving upon which objects may be stored or supported. Some objects may be bulky or heavy, and therefore difficult for a person to lift, maneuver, or otherwise move to and from a shelf. Additionally, the shelf may be located at an elevated height or position that is challenging to reach. Thus, moving an object to or from a shelf of this nature can be difficult, and may also present an increased risk of dropping and/or damaging an object being maneuvered on or moved to or from the shelf.

### SUMMARY OF THE INVENTION

The present invention provides a tiltable shelf system that may be incorporated into a support structure such as a mobile storage cart. The shelf system includes a shelf that that is rotatable and securable into one or more tilted or angled positions to assist a user in accessing or maneuvering objects to and from the shelf. A biasing member connected between the shelf and the support structure produces a biasing force to facilitate raising the shelf. The user may actuate a handle coupled to the shelf to selectively move a securing member—also coupled to the shelf—between a secured position and an unsecured position. The user may rotate the shelf to a desired orientation while the securing member is in the unsecured position. When the shelf is in the desired orientation, the user may actuate or release the handle to urge the securing member into the secured position so that the shelf cannot move relative to the support structure.

In one form of the present invention a tilting shelf system for a mobile support includes a shelf that may be pivotably coupled to the mobile support. A handle coupled to the shelf is movable between locked and unlocked positions. A securing member is also coupled to the shelf and is movable between secured and unsecured positions in response to movement of the handle from the locked to unlocked position. The shelf is immobilized relative to the mobile support by the securing member in the secured position, while the shelf is movable relative to the mobile support while the securing member is in the unsecured position.

In one aspect, a biasing member is coupled between the shelf and the mobile support, and biases the shelf toward a horizontal orientation. The biasing member is extendable and retractable along its longitudinal axis and produces a biasing force directed along its longitudinal axis. Optionally, the biasing member is a gas strut.

In another aspect, the shelf includes a rear side pivotably coupled between a pair of opposing sidewalls of the mobile support, and a front side adjustably coupled between the sidewalls of the mobile support via the securing member.

In yet another aspect, the shelf further includes a guard rail coupled to a top side proximate the front side of the shelf.

In still another aspect, the securing member is coupled proximate the front side and is selectively securable to at least one of the sidewalls of the mobile support to secure the shelf in a horizontal orientation or a tilted orientation. The handle may be pivotable between the locked and unlocked positions, and biased towards the locked position, in which the securing member is linearly extendable and retractable between the secured and unsecured positions in response to the pivoting motion of the handle. Optionally, a side plate is coupled to the mobile support and includes a horizontal position hole and a tilted position hole. The securing member is in the secured position and the shelf is in the horizontal orientation when the securing member is extended into the horizontal position hole. The securing member is in the secured position and the shelf is in the tilted orientation when the securing member is extended into the tilted position hole. The securing member is in the unsecured position when the securing member is retracted out of the horizontal and tilted position holes.

In a further aspect, an intermediate position hole is spaced between the horizontal and tilted position holes, such that the securing member is further in the secured position and the shelf is in an intermediate orientation between the horizontal orientation and the tilted orientation when the securing member is extended into the intermediate position hole, and the securing member is further in the unsecured position when the securing member is retracted out of the intermediate position hole.

In yet a further aspect, a sliding or rolling element coupled at a distal end of the securing member movably engages the side plate along arcuate paths between the horizontal and intermediate position holes, and the intermediate and tilted position holes. Optionally, a pair of ramp stops are coupled at the intermediate and tilted position holes, where the ramp stops urge the sliding or rolling element outwardly away from the side plate as the sliding or rolling element approaches the intermediate position hole or the tilted position hole.

In still a further aspect, the handle is coupled at the front side of the shelf. The handle may include a lever that is pivotable between the locked and unlocked positions. Optionally, a resilient member coupled to the lever biases the lever towards the locked position. Additionally, the securing member may linearly extend and retract between the secured and unsecured positions in response to the pivoting motion of the lever.

In another form of the present invention, an adjustable shelf system for a support structure includes a shelf that may be coupled to the support structure, and that includes a rear side located opposite a front side, and a first side located opposite a second side. A pair of biasing members have longitudinal axes and extend and retract along respective ones of the longitudinal axes, and produce a biasing force directed along the longitudinal axes towards the shelf in response to movement of the front side of the shelf relative to the rear side of the shelf. Each biasing member is coupled proximate a respective one of the first and second sides of the shelf, and may be coupled to the support structure. A handle coupled to the shelf is movable between locked and unlocked positions, while a securing member also coupled to the shelf is movable between secured and unsecured positions in response to movement of the handle between the locked and unlocked positions. The front side of the shelf does not move relative to the rear side of the shelf while the securing member is in the secured position, and the front side of the shelf is vertically adjustable relative to the rear side of the shelf while the securing member is in the unsecured position. Optionally, a second handle and a second securing member are identical to the handle and securing member, respectively, where each pair of identical components are located about a transverse axis of the shelf in an opposite and symmetrical fashion relative to one another.

In yet another form of the present invention, an adjustable support system for a support structure includes a support surface that is pivotably coupled to the support structure, and a securing member movable between secured and unsecured positions is also coupled to the support surface. A retention feature at the support structure may receive or otherwise engage the securing member. The securing member is in the secured position while it is engaged with the retention feature, and is in the unsecured position while it is disengaged from the retention feature. The support surface is immobile relative to the support structure while the securing member is in the secured position, and the support surface is movable relative to the support structure while the securing member is in the unsecured position. Optionally, a handle is coupled to the support surface and is movable between locked and unlocked positions, in which the securing member is movable between the secured and unsecured positions in response to movement of the handle between the locked and unlocked positions.

Thus, the tilting shelf system of the present invention provides an adjustable shelf pivotably and adjustably mounted to a support structure, such as a mobile storage cart for storing and moving objects in a warehouse, and allows a user to more easily or conveniently access, add, and remove objects to and from the shelf. A biasing member attached between the shelf and the support structure provides a biasing force to assist the user in adjusting the shelf. A handle and a securing member are also attached to the shelf, in which the handle is movable between locked and unlocked positions to actuate the securing member between secured and unsecured positions. The shelf is rotatable to a desired orientation while the securing member is in the unsecured position. Once the shelf has been rotated to a desired orientation, for example, an orientation in which a front side of the shelf is lower than a rear side of the shelf to allow the user improved access to the shelf or the objects positioned thereon, the user may actuate and/or release the handle to urge the securing member into the secured position. Once the securing member is in the secured position, the shelf will be stabilized and/or have a fixed position relative to the support structure to allow the user to freely access the shelf.

These and other objects, advantages, purposes and features of the present invention will become apparent upon review of the following specification in conjunction with the drawings.

### BRIEF DESCRIPTION OF THE DRAWINGS

FIG. 1 is a perspective view of a mobile cart fitted with a tilting shelf system in accordance with the present invention, with the shelf of the tilting shelf system shown in a tilted position;

FIG. 2 is another perspective view of the cart and tilting shelf system of FIG. 1, where the shelf is in a horizontal position;

FIG. 3 is a lower perspective view of the tilting shelf system of FIG. 1, where the tilting shelf system is not attached to the mobile support;

FIG. 4 is a rear perspective view of the tilting shelf system of FIG. 3;

FIG. 5 is a lower rear perspective view of the tilting shelf system of FIG. 3;

FIG. 6 is a perspective view of a portion of the tilting shelf system of FIG. 3, showing a handle coupled to the shelf;

FIG. 7 is a lower perspective view of the portion of the tilting shelf system of FIG. 6, showing an actuation assembly coupled to the handle;

FIG. 8 is a perspective view of a securing member of the tilting shelf system of FIG. 3, showing the securing member in a horizontal secured position;

FIG. 9 is a perspective view of the handle and the actuation assembly of FIG. 7;

FIG. 10 is a perspective view of a gas strut mounted to a side plate of the tilting shelf system of FIG. 1;

FIG. 11 is an exploded view of the tilting shelf system of FIG. 3;

FIG. 12 is a perspective view of an alternative handle and an alternative actuation assembly in accordance with the present invention;

FIG. 13 is a lower perspective view of the handle and the actuation assembly of FIG. 12;

FIG. 14 is a perspective view of the handle and the actuation assembly of FIG. 12;

FIG. 15 is a perspective view of another mobile cart fitted with a tilting shelf system in accordance with the present invention, where the shelf is shown in a horizontal position;

FIG. 16 is another perspective view of the cart and tilting shelf system of FIG. 15, where the shelf is in an intermediate tilted position;

FIG. 17 is another perspective view of the cart and tilting shelf system of FIG. 15, where the shelf is in a fully tilted position;

FIG. 18 is a lower frontal perspective view of the tilting shelf system of FIG. 15, with the mobile cart omitted;

FIG. 19 is an upper rear perspective view of the tilting shelf system of FIG. 18;

FIG. 20 is a lower rear perspective view of the tilting shelf system of FIG. 18;

FIG. 21 is an enlarged upper perspective view of a portion of the tilting shelf system of FIG. 18, showing a handle coupled to the shelf;

FIG. 22 is an enlarged lower perspective view of the portion of the tilting shelf system of FIG. 18, showing an actuation assembly coupled to the handle;

FIG. 23 is an upper perspective view of a securing member of the tilting shelf system of FIG. 18, showing the securing member in a horizontal secured position;

FIG. 24 is a perspective view of a gas strut mounted to a side plate of the tilting shelf system of FIG. 18;

FIG. 25 is a perspective view of the handle and actuation assembly of FIG. 22; and

FIG. 26 is an exploded view of the tilting shelf system of FIG. 18.

### DETAILED DESCRIPTION OF THE PREFERRED EMBODIMENTS

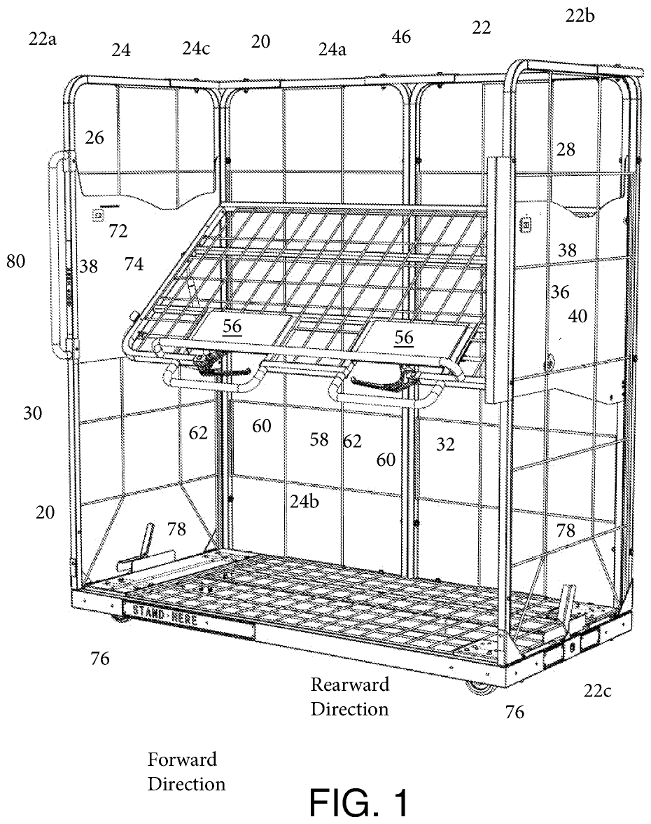

Referring now to the drawings and the illustrative embodiments depicted therein, an adjustable support system or tilting shelf system 20 may be constructed as part of, or retrofitted to, a support structure such as mobile support 22. Shelf system 20 allows a user to more easily access and maneuver objects to and from a shelf 24, which is rotatably and adjustably coupled to mobile support 22 as shown in FIGS. 1-5. For example, objects on the shelf 24 may readily slide down to a more accessible position at the lowered end of the shelf when tilted, and objects being placed on the shelf do not need to be lifted as high when the shelf is tilted, but can then be lifted by returning the shelf to a horizontal position. A rear side 24a of shelf 24 is rotatably coupled between a pair of side plates 26, 28, and a front side 24b is adjustably secured to side plates 26, 28, with side plates 26, 28 secured to opposing sides 22a, 22b of mobile support 22. A pair of handles 30, 32 are coupled to front side 24b of shelf 24 and are actuatable by the user to urge a pair of securing members 34, 36 between secured positions in which securing members 34, 36 are located in either a pair of horizontal position holes 38 or a pair of tilted position holes 40, and unsecured positions in which securing members are not located in position holes 38 or 40 to allow the user to rotate front side 24b of shelf 24 into a desired position. A pair of gas struts 42, 44 are coupled between lateral side portions 24c, 24d of shelf 24 and side plates 26, 28 and impart a biasing force to shelf 24, thus preventing undesired rapid movement or freefalling motion of front side 24b of shelf 24 while the user is adjusting shelf 24.

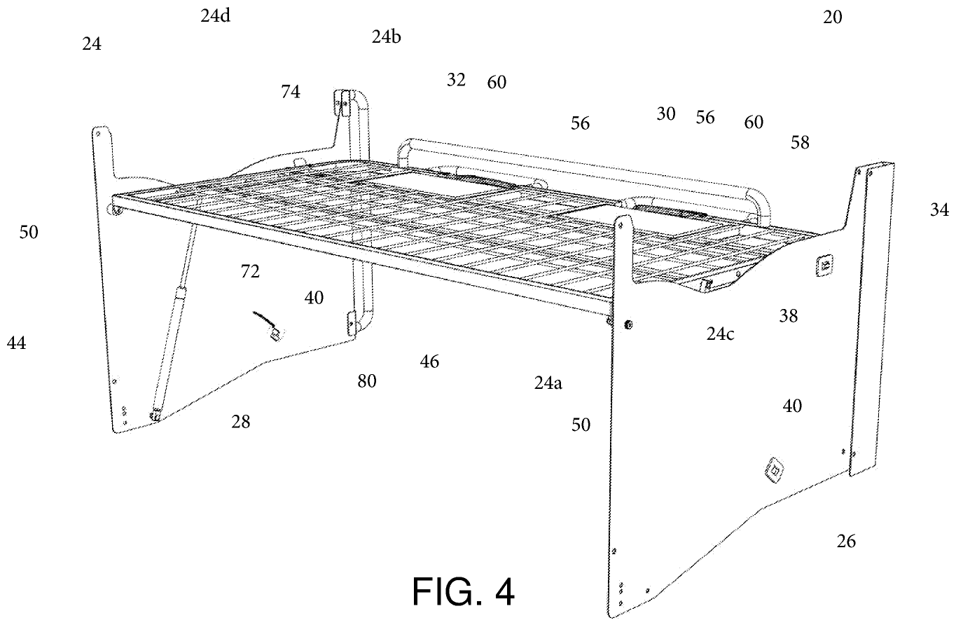

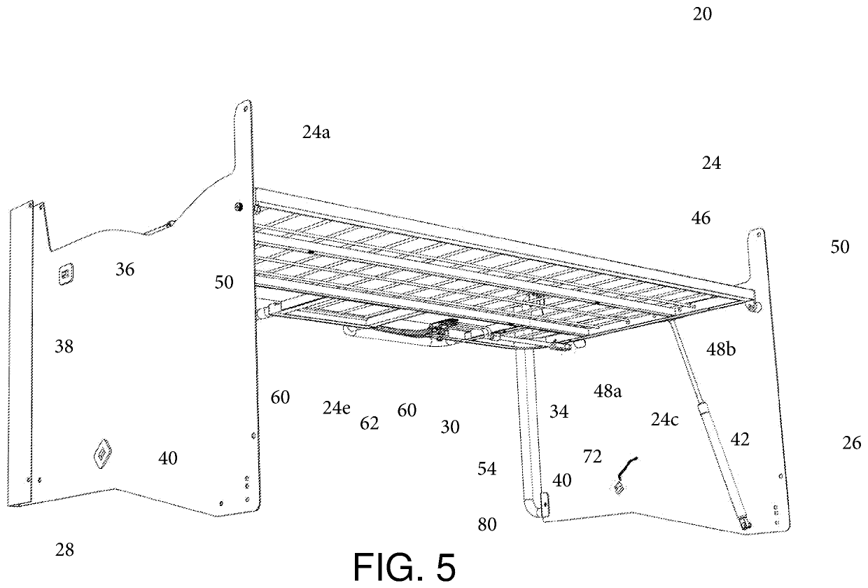

Shelf 24 includes an outer frame 46 and a pair of spaced-apart cross members 48a, 48b that support a wire mesh surface upon which objects may be supported. As shown in FIGS. 4 and 5, a pair of brackets 50 are attached to frame 46 where lateral side portions 24c, 24d meet rear side 24a of shelf 24, and define holes through which fasteners extend to rotatably couple rear side 24a of shelf 24 to side plates 26, 28. Frame 46 defines a pair of actuation areas 52 that provide a space for the movement of handles 30, 32 and a pair of actuation assemblies 54 (discussed below), as handles 30, 32 and actuation assembly 54 are at least partially located in the same plane as shelf 24. A pair of guard plates 56 are secured to shelf 24 to cover actuation areas 52, thus preventing objects resting on shelf 24 from getting trapped in actuation areas 52 and/or obstructing movement of handles 30, 32 or actuation assemblies 54, while also increasing the available surface area of shelf 24 for storing objects. A guard rail 58 attached to frame 46 at front side 24b and/or a top side 24f of shelf 24 extends upward from shelf 24 to reduce the likelihood of objects from sliding, rolling, or inadvertently falling off shelf 24, particularly when shelf 24 is tilted or being adjusted. Shelf 24 has a transverse axis about which various structurally-identical pairs of components are symmetrically positioned relative to one another, including handles 30, 32, securing members 34, 36, gas struts 42, 44, and side plates 26, 28.

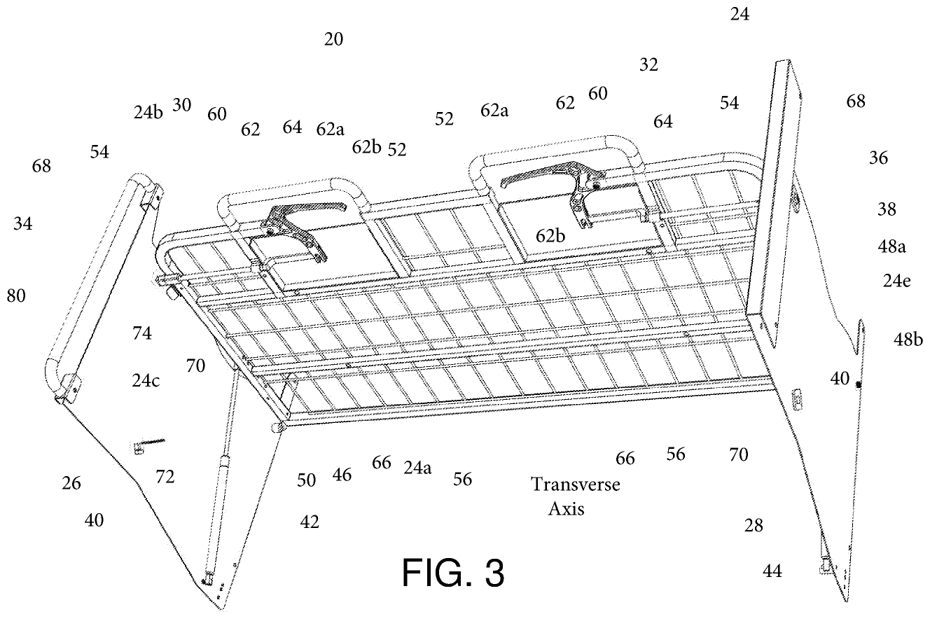

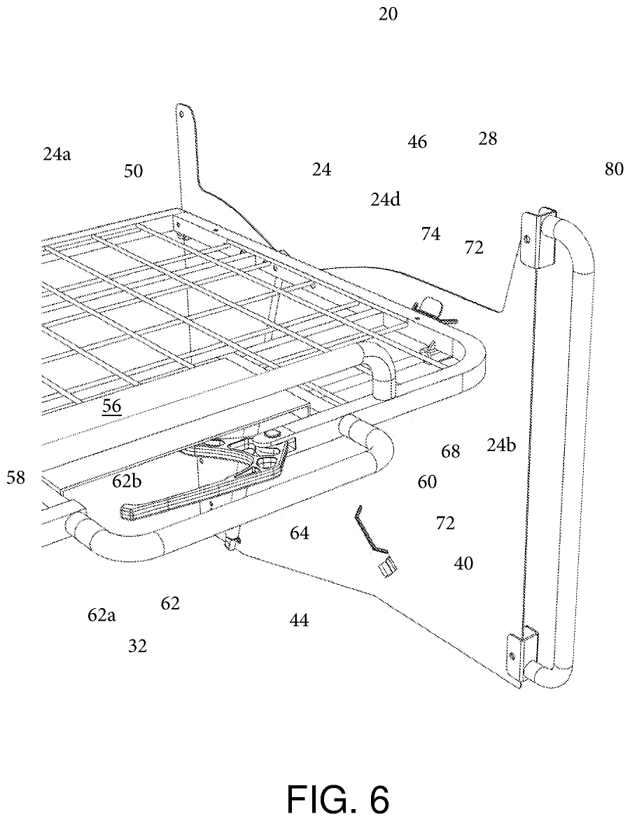

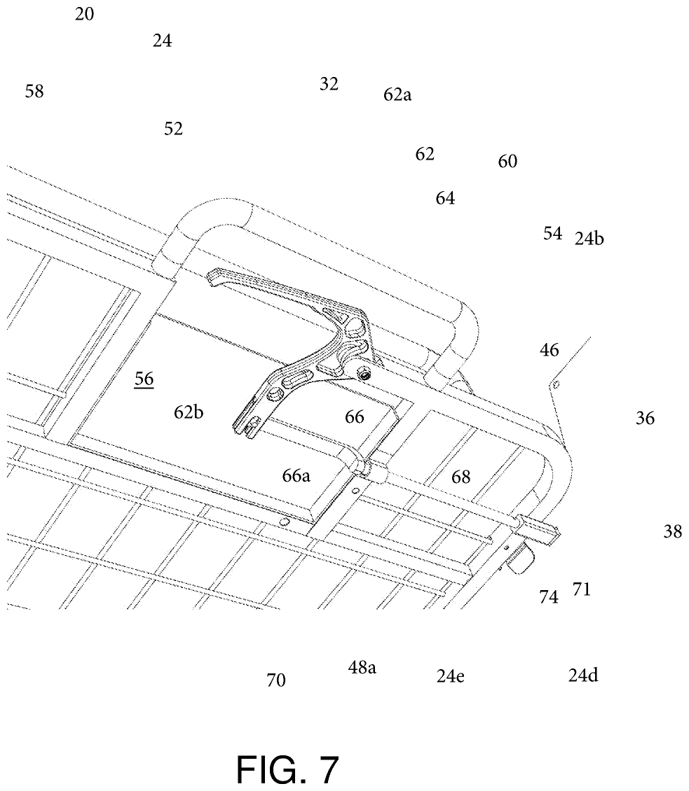

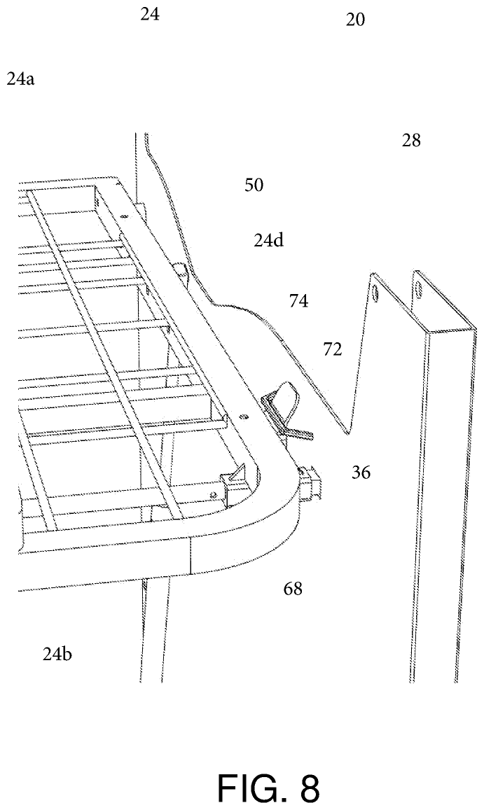

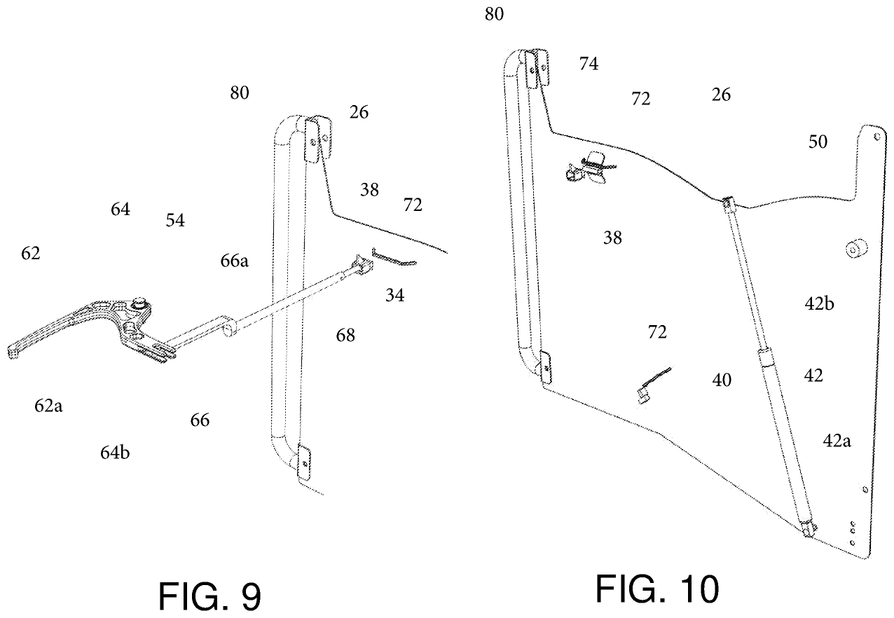

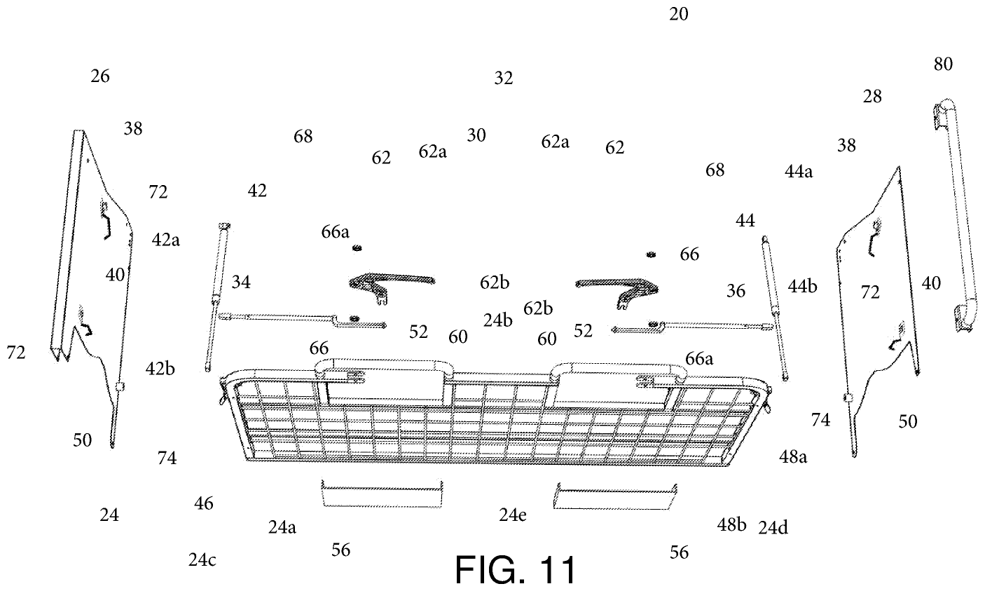

Referring to FIGS. 3, 6, 7, 9, and 11, handles 30, 32 are attached to front side 24a of shelf 24 to provide the user with convenient and continuous access to handles 30, 32 while tilting and/or adjusting front side 24a of shelf 24. Each handle 30, 32 includes a gripping portion in the form of a U-shaped grip 60 attached to frame 46 at front side 24a and extending in a forward direction away from shelf 24, and an actuatable lever 62. Levers 62 are pivotable about a pair of lever pivots 64 between locked positions to urge securing members 34, 36 into the secured positions, and unlocked positions to urge securing members 34, 36 into the unsecured positions. The user may, for example, pivot and/or rotate levers 62 by squeezing levers 62 towards grips 60, in which case the user may utilize grips 60 for hand support as the user squeezes levers 62 with their fingers toward the palm of their hand. A biasing mechanism or device such as a resilient member, for example, a torsion spring, an extension spring, or a compression spring, is coupled between each lever 62 and shelf 24 or other component to bias each lever 62 towards its locked position such that levers 62 have default locked positions. Each lever 62 includes a forward arm 62a that is rotatable towards grips 60 to place levers 62 into the unlocked positions until the user releases and/or lets go of forward arms 62a, thus causing the biasing mechanisms to automatically urge levers 62 back into the locked positions. Levers 62 include rear arms 62b that rotate in response to the rotation of forward arms 62a.

Actuation assemblies 54 include interconnected actuation links that transfer and/or translate the rotational motion of levers 62 moving between the locked and unlocked positions into the linear motion of securing members 34, 36 between the secured and unsecured positions. Actuation assemblies 54 each include a lever link 66 slidably coupled to one of rear arms 62b via a slot 68 defined by each rear arm 62b, and has a curved end portion 66a rotatably coupled to an end link 68. Curved end portions 66a transfer the motion of rear arms 62b—located in the same plane as shelf 24—to end links 68 located beneath shelf 24. End links 68 extend through and are supported by a pair of mounts 70, 71 secured to a bottom side 24e of shelf 24, and are coupled to securing members 34, 36. As rear arms 62b of levers 62 are rotated as previously described, lever links 66 slide within slots 68 such that lever links 66 move only in the lateral direction, and thus simultaneously move end links 68 and securing members 34, 36 in the lateral direction.

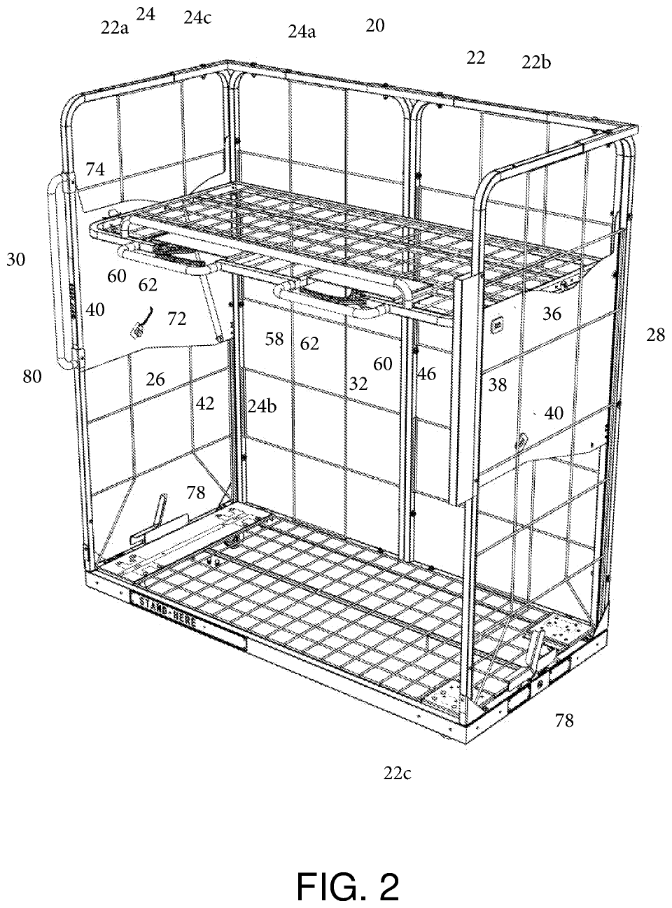

Rotation of levers 62 into the unlocked positions causes inboard lateral motion of lever links 66, end links 68, and securing members 34, 36, thus urging securing members 34, 36 from the secured positions to the unsecured positions. Specifically, securing members 34, 36 move from secured positions in which they are at least partially located within or at least partially protrude into position holes 38 or 40 such that the movement of securing members 34, 36 and shelf 24 relative to mobile support 22 is blocked, constrained or not possible, to the unsecured positions in which securing members 34, 36 are retracted or pulled out of position holes 38 or 40 to allow securing members 34, 36 and shelf 24 to be rotated and/or adjusted relative to mobile support 22. Conversely, rotation of levers 62 back into the locked positions causes outboard lateral motion of lever links 66, end links 68, and securing members 34, 36, such that securing members 34, 36 will extend and/or protrude into either horizontal position holes 38 once shelf 24 is rotated to a horizontal and/or level orientation (FIG. 2), or tilted position holes 40 once shelf 24 is rotated into a tilted and/or angled orientation (FIG. 1). The user may release levers 62 from the unlocked positions while moving or adjusting the orientation of shelf 24, in which case securing members 34, 36 will slide along inner surfaces of side plates 26, 28. Because lever 62 is biased towards the locked position, which also biases securing members 34, 36 laterally outboard, securing members 34, 36 will automatically extend and/or protrude back into position holes 38 or 40 when shelf 24 reaches either the horizontal or tilted orientations if the user is not holding levers 62 in the unlocked positions. It should be appreciated that a locking mechanism may be added to a handle which could lock a handle lever into an unlocked position such that securing members 34, 36 would not slide and/or scrape against side plates 26, 28 as shelf 24 is being rotated.

Securing members 34, 36, which may be a bolt, a pin, or a latch, for example, are extendable into either a horizontal secured position in which they protrude into horizontal position holes 38 to secure shelf 24 in the horizontal orientation, or a tilted secured position in which securing members 34, 36 protrude into tilted position holes 40 to secure shelf 24 in the tilted orientation (FIGS. 1, 2, 4, 5, and 10). A series of loops 72 are coupled to side plates 26, 28 at position holes 38 and 40 and interact and/or engage with protrusions or hooks 74 coupled to frame 46 at lateral end portions 24c, 24d to act as hard stops that limit the maximum rotation of shelf 24, thus preventing the inadvertent over travel of shelf 24 past the horizontal and lateral orientations while shelf 24 is being rotated. It should be appreciated that a shelf may be adjusted into additional orientations and/or positions apart from what has been described above, for example, by having a side plate with additional position holes located at additional locations. Furthermore, a retention feature such as a hole, opening, device, or fixture mounted to or defined by the support structure, that selectively receives or engages with a shelf or a feature or device coupled to the shelf, could be used for purposes of securing the shelf into varying positions.

As shown in FIGS. 2-5 and 10, biasing members in the form of extendable struts 42, 44 having spring-loaded or gas charged cylinders 42a, 44a containing pistons that are movable relative to rods 42b, 44b, are rotatably coupled between side plates 26, 28 and lateral end portions 24c, 24d of shelf 24. Struts 42, 44 are extendable and retractable along their longitudinal axes in response to the rotation and/or movement of shelf 24 relative to mobile support 22, in which during the extension or retraction of struts 42, 44, air is exchanged between an external environment and an interior portion of struts 42, 44. The speed at which struts 42, 44 may extend or retract depends on the air exchange rate between the external environment and the interior portion of struts 42, 44, where the air exchange rate may be adjusted via an adjustable valve coupled to struts 42, 44. Accordingly, the extension and retraction speed limitations of struts 42, 44 provide a biasing force that is directed along their longitudinal axis to similarly limit and/or regulate the speed at which shelf 24 may be moved relative to mobile support 22. Additionally, the biasing force produced by struts 42, 44 may also provide assistance in moving shelf 24 relative to mobile support 22. For example, the user may be rotating shelf 24 upward from the tilted orientation to the horizontal orientation, in which case struts 42, 44 may bias or push shelf 24 towards the horizontal orientation. It should be appreciated that a biasing member may take alternative forms, including an electromechanical strut or device having a motor that produces a biasing force to control or assist with moving and/or rotating shelf 24 relative to mobile support 22.

Using the tilting shelf system 20 described above, the user may adjust shelf 24, for example, from the horizontal orientation to the tilted orientation. To illustrate, the user may squeeze levers 62 out of the default locked positions and into the unlocked positions, in which actuation assemblies 54 transfer the motion of levers 62 to securing members 34, 36 to remove securing members 34, 36 from horizontal position holes 38. The user may then begin rotating shelf 24 or allow shelf 24 to rotate downward towards its tilted orientation, and may optionally release levers 62 once securing members 34, 36 have been rotated out of alignment with horizontal position holes 38. Struts 42, 44 at least partially inhibit the downward rotation of shelf 24 by producing a biasing force along the longitudinal axes of struts 42, 44 directed towards shelf 24 to slow and/or regulate the rotational speed of shelf 24 as shelf 24 rotates toward its tilted orientation. Once shelf 24 has reached its desired tilted orientation, securing members 34, 36 will automatically extend into tilted position holes 40 if the user is not holding levers 62 in the unlocked positions. The user may then more easily access shelf 24 to add, remove and/or maneuver objects to, from, and/or on shelf 24. Following a similar process, the user may return shelf 24 back to the horizontal orientation by rotating shelf 24 upward, in which the upward rotation of shelf 24 may be assisted by struts 42, 44.

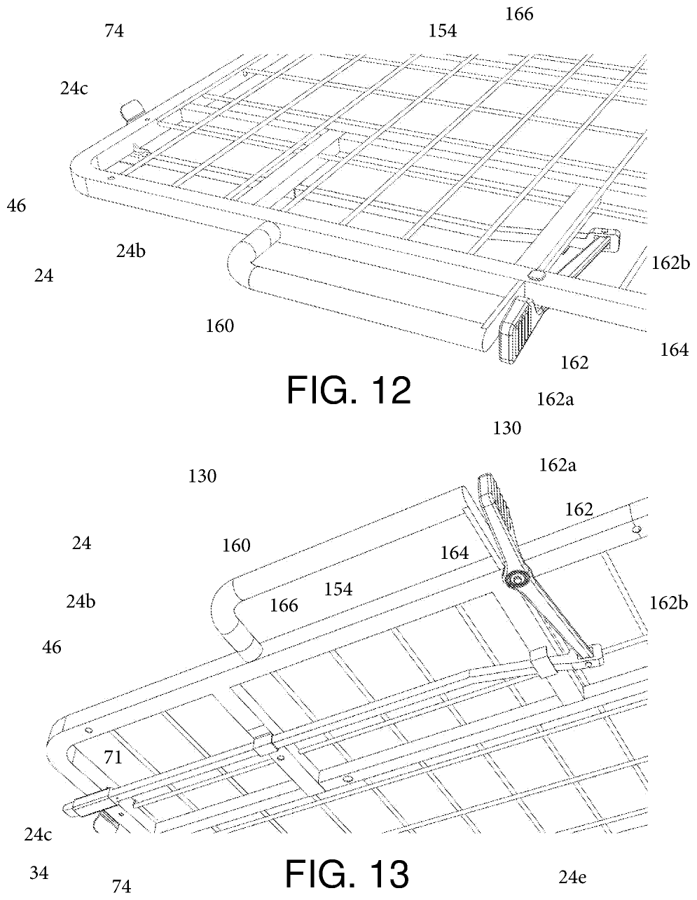

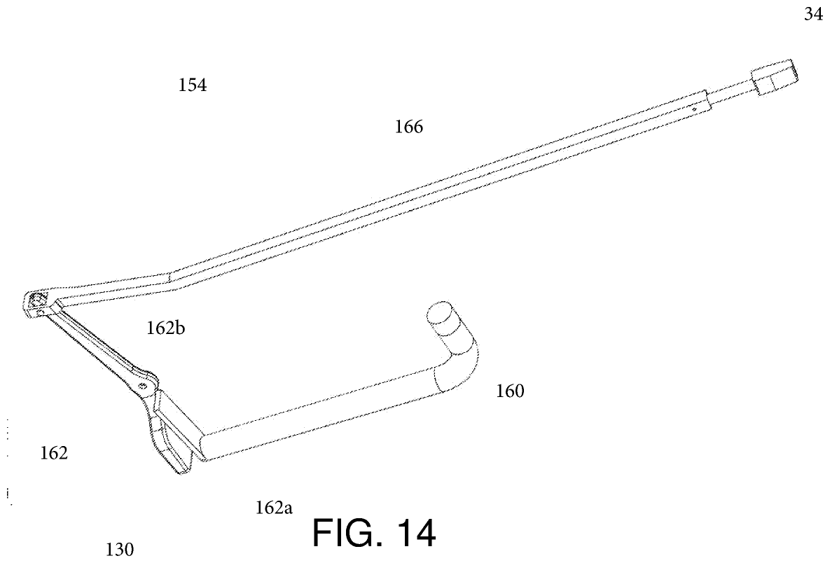

It should be appreciated that a handle and/or an actuation assembly may vary within the scope of the present invention. For example, with reference to the illustrated embodiment of FIGS. 12-14, an alternative handle 130 and an alternative actuation assembly 154 are shown that collectively perform the same functions as handle 30 and actuation assembly 54 described above. Handle 130 includes a U-shaped grip 160 having a straight and/or flat inboard side 160a located adjacent to a paddle 162. Paddle 162 is pivotable about a paddle pivot 164 coupled to bottom side 24e of shelf 24, and includes a blade 162a configured to be moved by the user's thumb to pivot paddle 162 about paddle pivot 164, and a shaft 162b connected to blade 162a. Actuation assembly 154 includes a paddle link 166 pivotably coupled to shaft 162b, and coupled to securing member 34. The user may pivot paddle 162 about paddle pivot 164, for example, by gripping or grasping grip 160 and pressing and/or moving blade 162a with the user's thumb towards grip 160 to an unlocked position. The pivoting motion of paddle 162 urges both paddle link 166 and securing member 34 laterally inboard such that securing member 34 moved into the unsecured position. The user may release or break contact with blade 162a, in which case a biasing member may bias paddle 162 back into a locked position. It should be appreciated that a tilting shelf system may have more or less than two handles and/or actuation assemblies within the scope of the present invention. Additionally, a tilting shelf system may include as an alternative to a handle one or more buttons and/or other toggling mechanisms that could be pushed, pulled, slid, rotated, or otherwise actuated between locked and unlocked positions.

Tilting shelf system 20 may be manufactured as part of mobile support 22, or may be manufactured as a separate component that is securable to mobile support 22. As shown in FIGS. 1-5, mobile support 22 includes a series of caster wheels 76 connected to a lower platform or base 22c. A pair of foot brakes 78 are secured to opposing lateral sides of base 22c, and are actuatable to brake or inhibit the rotational motion of caster wheels 76. A vertically-oriented handgrip 80 is secured to a front side of sidewall 22a of mobile support 22, and may be gripped by the user to assist the user in maneuvering mobile support 22 around a facility such as a warehouse, for example. Although tilting shelf system 20 has been described with reference to mobile support 22, it should be appreciated that a tilting shelf system may be attached to, manufactured as part of, or otherwise used with any support structure having or configured to have a shelf or storage surface.

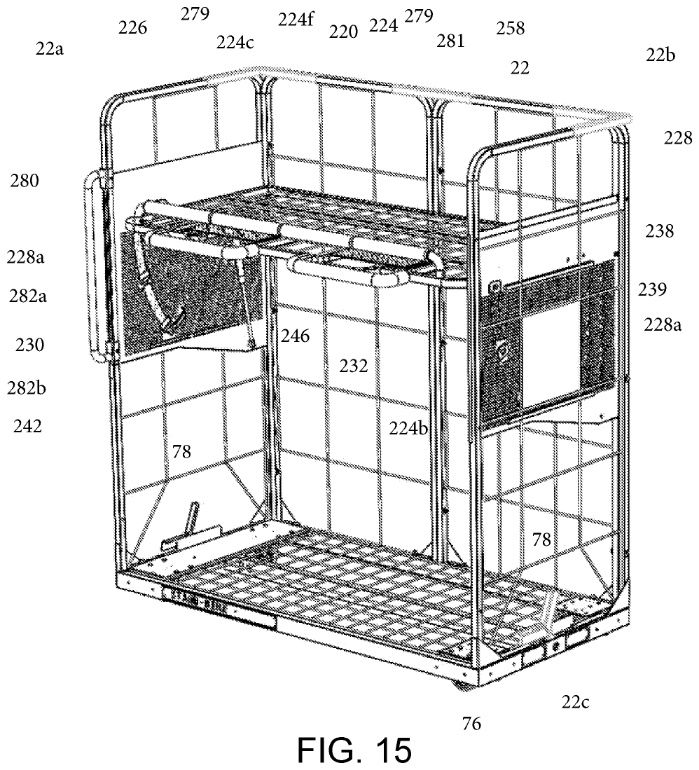

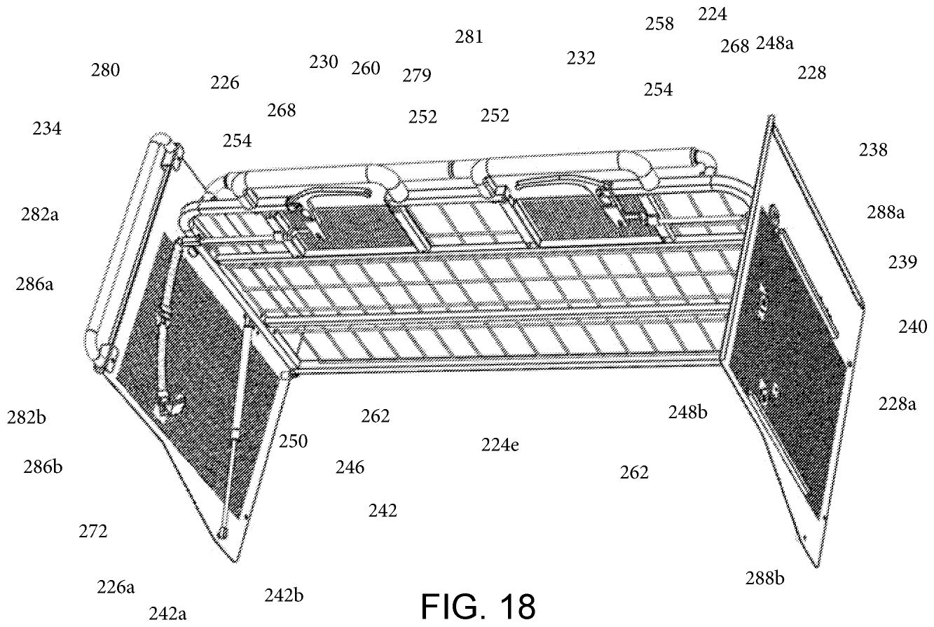

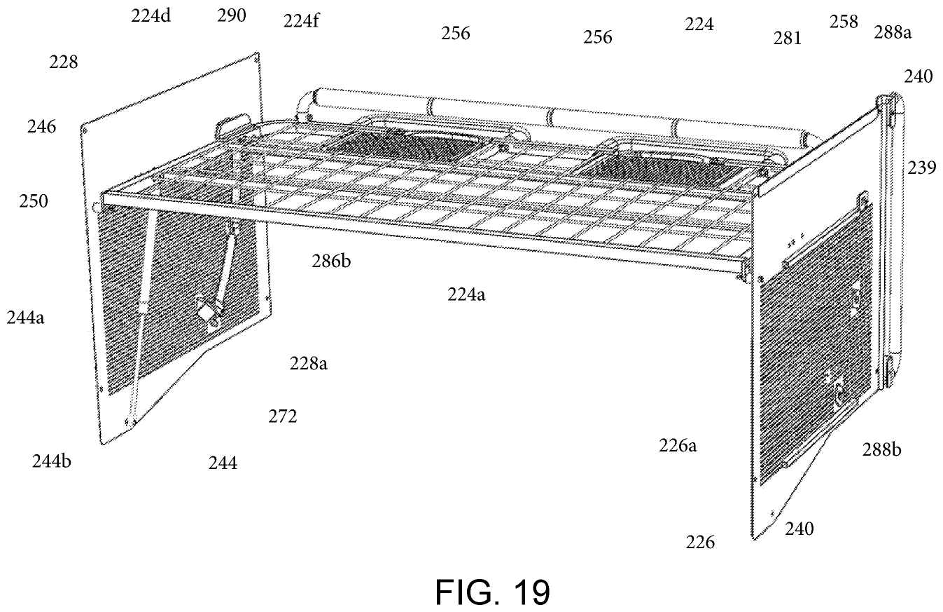

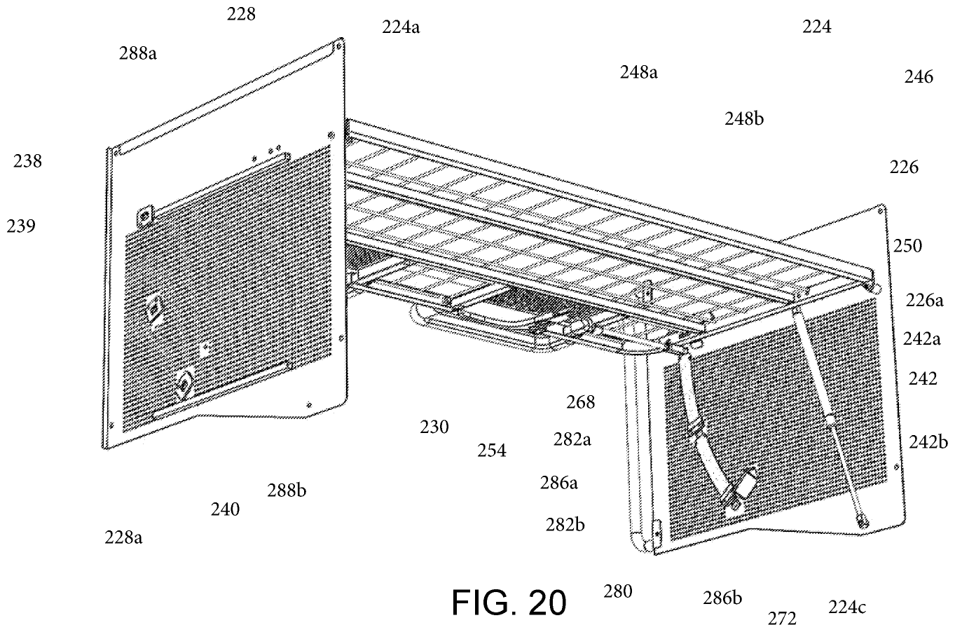

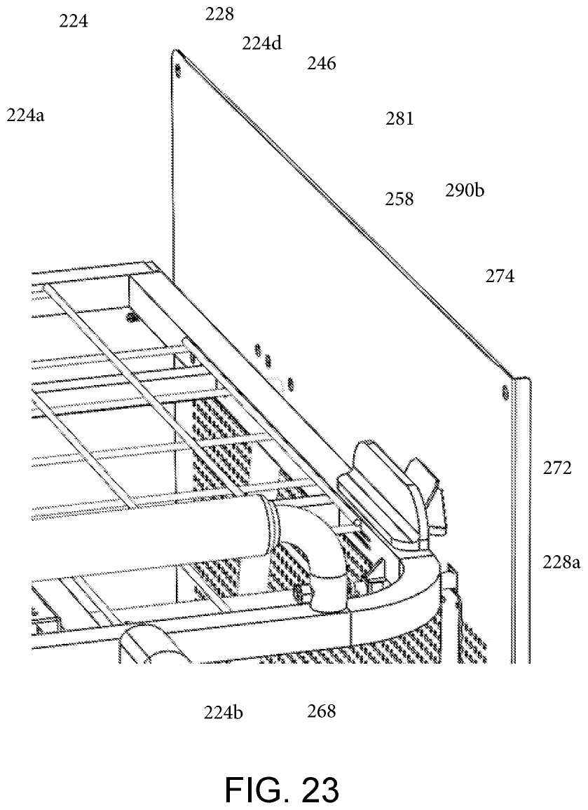

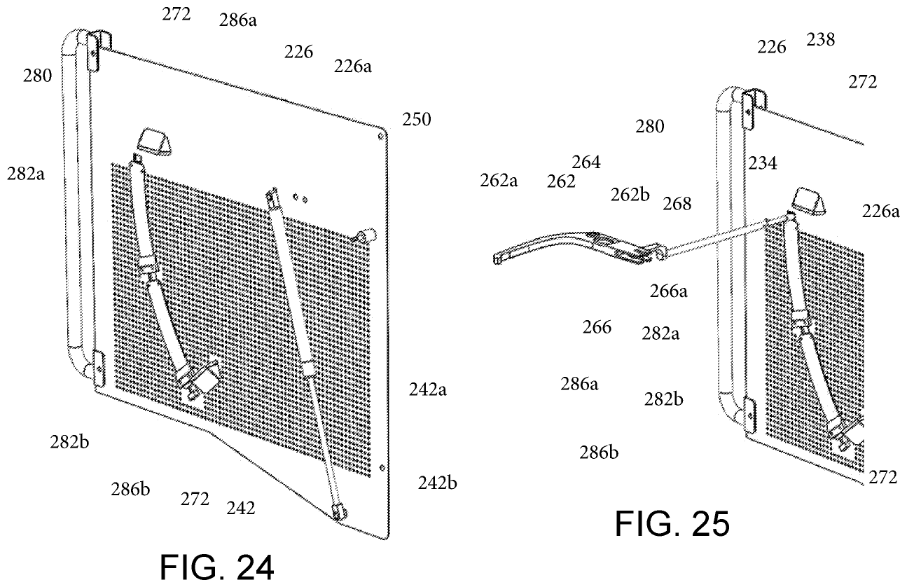

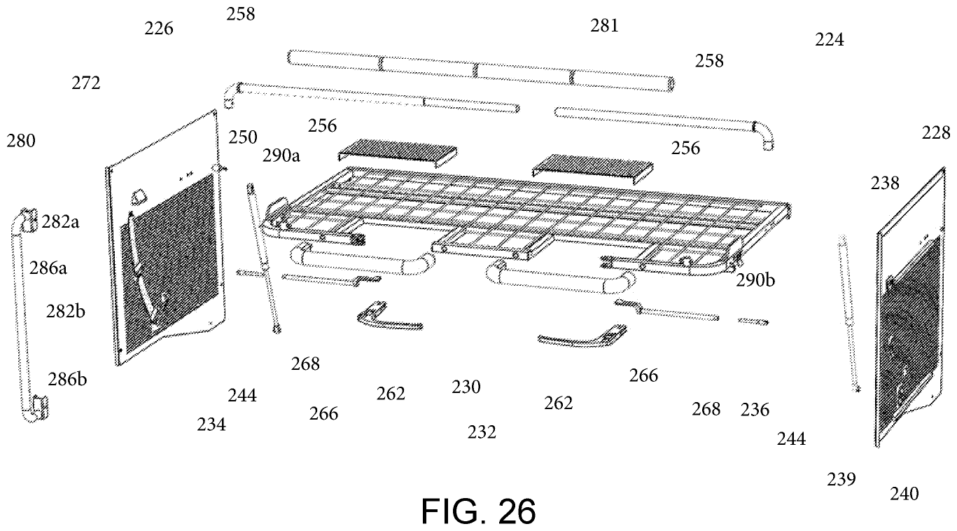

Referring now to FIGS. 15-26, another adjustable support system or tilting shelf system 220 is shown that is similar to tilting shelf system 20, with similar features of tilting shelf system 220 relative to tilting shelf system 20 being designated with like reference numerals, but with “200” added to each reference numeral of tilting shelf system 20. Due to the similarities of tilting shelf system 220 relative to tilting shelf system 20, not all of the components and features of tilting shelf system 220 are discussed herein, but they will be readily understood upon reference to the above descriptions. Like tilting shelf system 20, tilting shelf system 220 may be constructed as part of, or retrofitted to, a support structure such as mobile support 22, such as shown in FIGS. 15-17. Tilting shelf system 220 includes a shelf 224 having a rear side 224a located opposite a front side 224b, in which rear side 224a is pivotably secured between sidewalls 22a, 22b of mobile support 22 via mounts and/or brackets 250. Cross members 248a, 248b provide support to the mesh and/or perforated surface of shelf 224 (FIGS. 18, 20, and 22). A restraint bar or guard rail 258 is mounted to an outer frame 246 of shelf 224 at front side 224b and/or a top side 224f of shelf 224 to help support and/or restrain objects supported on shelf 224 (FIGS. 15-19, 21-23, and 26). A pair of biasing members in the form of gas struts 242, 244 each include gas charged cylinders 242a, 244a and rods 242b, 244b, and are mounted between oppositely located lateral end portions 224c, 224d of shelf 224 and respective sidewalls 22a, 22b of mobile support 22 to provide a biasing force along respective longitudinal axes of gas struts 242, 244 in response to motion of shelf 224 (FIGS. 15, 18, 19-21, and 24-26). A handgrip 280 is coupled to sidewall 22a of mobile support 22 for assisting an operator in maneuvering mobile support 22. It will be appreciated that other biasing devices, such as torsion springs, servo motors, or the like, may be used in place of gas struts.

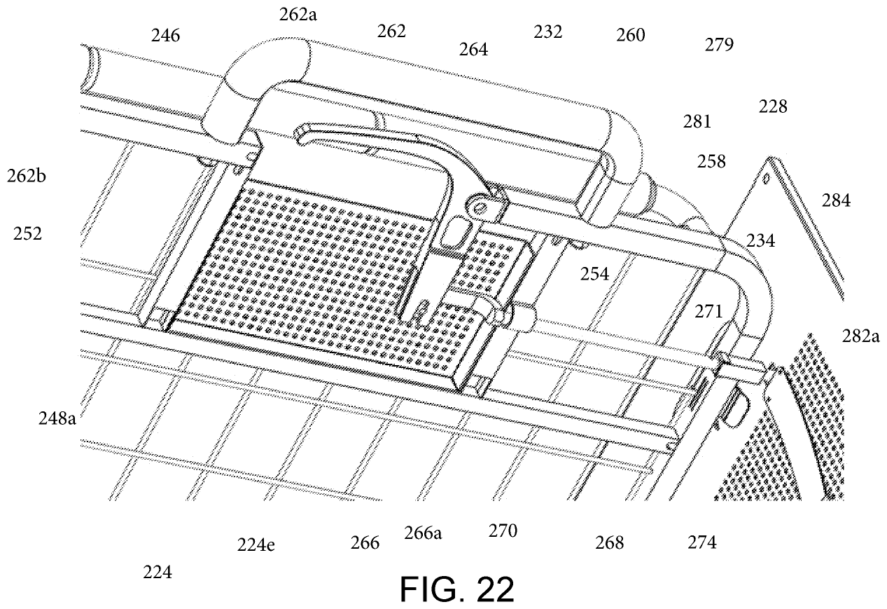

A pair of handles 230, 232 are mounted to front side 224b of shelf 224, and include U-shaped grips 260 and pivotable levers 262, where U-shaped grips 260 partially extend around pivotable levers 262, where levers 262 are located beneath meshed and/or perforated guard plates 256. Levers 262 are pivotable about respective lever pivots 264 between locked and unlocked positions to urge a pair of securing members 234 and 236 (FIGS. 18, 25, and 26) between a secured position and an unsecured position (discussed below), and include forward arms 262a and rear arms 262b. A pair of actuation assemblies 254 (FIG. 22) are operatively coupled to handles 230, 232, and each include a lever link 266 slidably coupled to a rear arm 262b via a slot 268 defined by rear arm 262b (FIGS. 22, 25, and 26). Each lever link 266 further includes a curved end portion 266a rotatably coupled to a respective end link 268 extending through a pair of mounts 270, 271 secured to a bottom side 224e of shelf 224, and are coupled to a respective securing member 234, 236. Actuation areas 252 (FIGS. 18 and 22) provide space for various components discussed above to move and/or be actuated. Handles 230, 232, and guard rail 258 may be coupled or secured to mobile support 22 via one or more fasteners such as a bolt that is threaded into a receiving hole and/or nut. Additionally, foam grips or coverings 279 and 281 cover portions of handles 230, 232 and guard rail 258, respectively, to provide cushioned support to an operator while gripping these features, and/or to reduce the likelihood of objects being damaged that come into contact with these components.

A pair of side plates 226, 228 are mounted or coupled to sidewalls 22a, 22b, each side plate 226, 228 including a respective mesh area 226a, 228a defining an array or series of holes to form a perforated or mesh-like structure. Side plates 226, 228 include retention features such as holes for receiving or engaging with securing members 234, 236 (FIGS. 18, 25, and 26), in which securing members 234, 236 may be in a secured position while engaged with the retention features, and an unsecured position when not engaged with the retention features. As previously discussed, shelf 224 is substantially immobile relative to mobile support 22 when securing members 234, 236 are in the secured position. On the other hand, front side 224b of shelf 224 is pivotable or movable while securing members 234, 236 are in their unsecured positions.

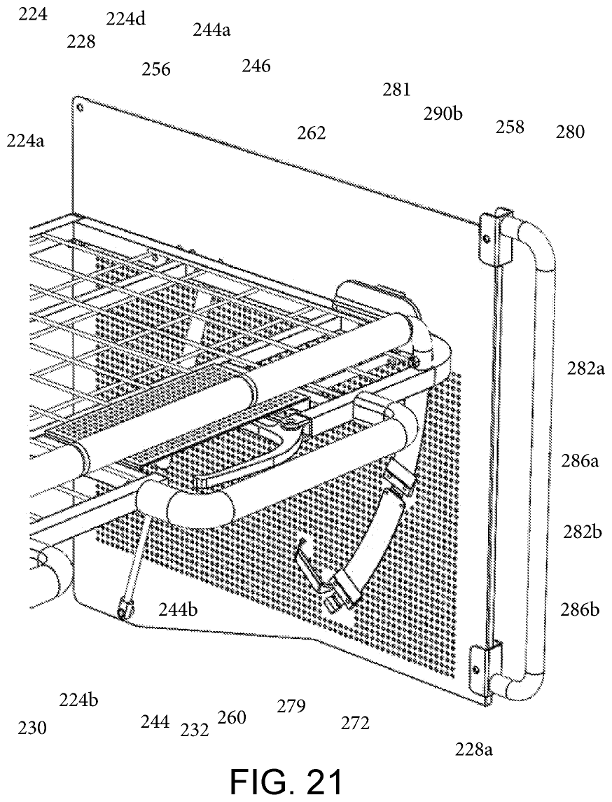

Retention features in the form of position holes receive portions of securing members 234, 236 in the secured position, such as shown in FIG. 25. In particular, side plates 226, 228 include a horizontal position hole 238, a tilted position hole 240, and an intermediate position hole 239 located between horizontal position hole 238 and tilted position hole 240 along an arcuate path that generally corresponds to a path of motion that a respective securing member 234, 236 follows as shelf 224 is pivoted about rear side 224a and/or brackets 250 (FIGS. 15-18, 20, and 22). Upper and lower arcuate wear plates 282a, 282b are part of or coupled to side plates 226, 228 along at least a portion of the above-noted arcuate paths, and provide a substantially smooth surface along which a pair of sliding or rolling elements 284, at distal ends of securing members 234, 236, slide or roll along (FIG. 22). Sliding or rolling elements 284 may be axle-supported roll pins, ball bearings, or simply the exposed ends of securing members 234, 236, for sliding and/or rolling along the respective arcuate wear plates 282a, 282b (FIGS. 22 and 24-26). Upper arcuate wear plate 282a is located between horizontal position hole 238 and intermediate position hole 239, while lower wear plate 282b is located between intermediate position hole 239 and tilted position hole 240. As best shown in FIGS. 21, 24, and 25, a series of ramp stops 286a, 286b are part of or coupled to side plates 226, 228 along the arcuate path and/or wear plates 282a, 282b at an upper side of intermediate position holes 239 and tilted position holes 240. In particular, an intermediate ramp stop 286a is located between horizontal position hole 238 and intermediate position hole 239, and a tilted ramp stop 286b is located between intermediate position hole 239 and tilted position hole 240.

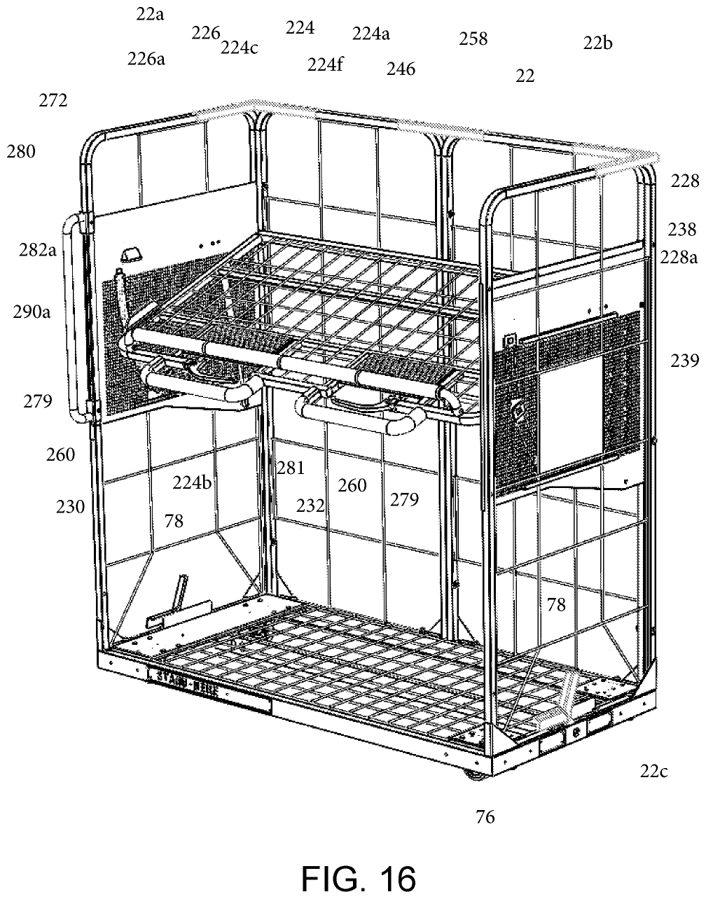

Upper and lower guard members 288a, 288b (FIGS. 18-20) are located above and below mesh areas 226a, 228a of side plates 226, 228, respectively, and serve as a spacer to prevent various components, such as ramp stops 286a, 286b, from being damaged as a result of mobile cart 22 being positioned and/or moved against an adjacent object or structure, such as another mobile cart or a wall. Hard stops 272 are coupled to side plates 226, 228 proximate position holes 238, 240 to engage protrusions or hooks 274 coupled to frame 246 at lateral end portions 224c, 224d to act as hard stops that limit the maximum rotation of shelf 224. A pair of safety guards or L-brackets 290a, 290b (FIGS. 16, 17, 19, 21, 23, and 26) are mounted at top side 224f of shelf 224 proximate lateral end portions 224c, 224d to prevent objects located and/or supported by shelf 224 from becoming ensnared, pinched, or snagged due to the rotation of shelf 224.

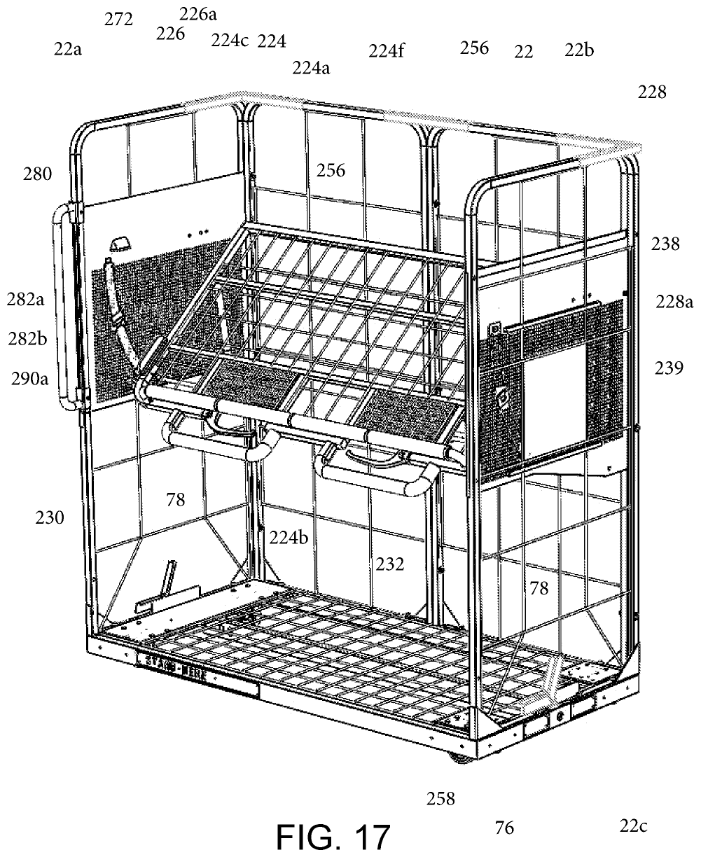

Tilting shelf system 220 may be operated in a similar manner to tilting shelf system 20, to pivotably adjust the orientation of shelf 224 between different positions. That is, actuation assemblies 254 may be adjusted from a locked position in which securing members 234, 236 are biased outwardly towards respective secured positions (as shown in FIGS. 18, 22, and 25), to an unlocked position in which securing members 234, 236 are retracted into respective unsecured positions (not shown) to allow for shelf 224 to be pivoted and/or rotated relative to mobile support 22. In particular, shelf 224 may be pivoted and secured in a horizontal orientation (FIG. 15) where securing members 234, 236 are extended into secured positions within horizontal position holes 238. Shelf 224 may also be pivoted and secured in an intermediate orientation (FIG. 16) located between the horizontal orientation and a tilted orientation, discussed below, in which securing members 234, 236 are extended into secured positions within intermediate position holes 239. Shelf 224 is further pivotable and securable in the tilted orientation (FIG. 17) where securing members 234, 236 are extended into secured positions within tilted position holes 240.

When lowering and/or downwardly rotating front side 224b of shelf 224, intermediate ramp stops 286a push sliding or rolling elements 284 away from side plates 226, 228 to slow the downward motion of front side 224b as it approaches intermediate position hole 239, while lower ramp stops 286b do the same at tilted position hole 240. In this way, ramp stops 286a, 286b provide a controlled deceleration and a physical or sensory-based indication to an operator that shelf 224 is nearing its intermediate orientation or tilted orientation to thus assist an operator in controlling the downward pivoting motion of shelf 224 as it approaches its intermediate orientation or tilted orientation. As a consequence, abrupt stops or harsh impacts that could damage or displace objects supported on shelf 224, or decrease the operational lifetime of various components such as securing members 234, 236, may be reduced or mitigated. Furthermore, by controlling the deceleration of shelf 224 as discussed above, ramp stops 286a, 286b may reduce the likelihood of accidental dislodgement of securing members 234, 236 from intermediate position holes 239 and tilted position holes 240.

Accordingly, the tilting shelf system of the present invention provides a user with the ability to selectively adjust and secure the orientation of a shelf relative to a support structure, such as a mobile or wheeled support structure used in a warehouse for storing and/or moving objects. The shelf is rotatably coupled to the support structure at a rear side, and has a front side that may be selectively secured and desecured to the support structure via securing members when the user actuates one or more handles. While the front side of the shelf is desecured from the support structure, the user may tilt the front side downward until the shelf reaches a desired tilted orientation in which the front side of the shelf may again be secured to the support structure via the securing members. In the tilted orientation, it may be easier for the user to access the shelf, for example, to remove an object from the shelf. The user may rotate the shelf upward and back into a horizontal orientation using the same components in a similar fashion. A pair of gas struts coupled between the support structure and the shelf produce a biasing force that acts on the shelf to assist the user when rotating the shelf.

Changes and modifications in the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. A tilting shelf system for a mobile support, said tilting shelf system comprising:
a shelf configured to be pivotably coupled to the mobile support;
a handle coupled to said shelf and movable between locked and unlocked positions; and
a securing member coupled to said shelf and movable between secured and unsecured positions in response to movement of said handle from said locked position to said unlocked position;
wherein said shelf is immobilized relative to the mobile support by said securing member in said secured position; and
wherein said shelf is movable relative to the mobile support while said securing member is in said unsecured position.

2. The tilting shelf system of claim 1, wherein said shelf comprises a rear side pivotably coupled between a pair of opposing sidewalls of the mobile support, and a front side adjustably coupled between the sidewalls of the mobile support via said securing member.

3. The tilting shelf system of claim 2, wherein said securing member is coupled proximate said front side and is selectively securable to at least one of the sidewalls of the mobile support to secure said shelf in a horizontal orientation or a tilted orientation.

4. The tilting shelf system of claim 3, wherein said handle is pivotable between said locked and unlocked positions, and is biased towards said locked position, and wherein said securing member is linearly extendable and retractable between said secured and unsecured positions in response to the pivoting motion of said handle.

5. The tilting shelf system of claim 3, further comprising a side plate coupled to the mobile support and comprising a horizontal position hole and a tilted position hole, wherein said securing member is in said secured position and said shelf is in said horizontal orientation when said securing member is extended into said horizontal position hole, wherein said securing member is in said secured position and said shelf is in said tilted orientation when said securing member is extended into said tilted position hole, and wherein said securing member is in said unsecured position when said securing member is retracted out of said horizontal position hole and said tilted position hole.

6. The tilting shelf system of claim 5, wherein said side plate further comprises an intermediate position hole spaced between said horizontal position hole and said tilted position hole, wherein said securing member is further in said secured position and said shelf is in an intermediate orientation between said horizontal orientation and said tilted orientation when said securing member is extended into said intermediate position hole, and wherein said securing member is further in said unsecured position when said securing member is retracted out of said intermediate position hole.

7. The tilting shelf system of claim 6, wherein said securing member comprises a distal end configured to movably engage said side plate along arcuate paths between said horizontal position hole and said intermediate position hole, and said intermediate position hole and said tilted position hole.

8. The tilting shelf system of claim 7, wherein said side plate further comprises a pair of ramp stops coupled at said intermediate position hole and said tilted position hole, said ramp stops urging said securing member away from said side plate as said securing member approaches said intermediate position hole or said tilted position hole.

9. The tilting shelf system of claim 8, wherein said side plate comprises an arcuate wear plate that is engaged by said distal end of said securing member as said securing member traverses between said position holes.

10. The tilting shelf system of claim 9, further comprising a protrusion stop coupled to said side plate and spaced from each opposite end of said arcuate wear plate, wherein said protrusion stops are engageable by said front side of said shelf to define a maximum rotation of shelf.

11. The tilting shelf system of claim 2, wherein said shelf further comprises a top side and a guard rail coupled to said top side proximate said front side.

12. The tilting shelf system of claim 1, further comprising a biasing member coupled between said shelf and the mobile support, and configured to bias said shelf toward a horizontal orientation.

13. The tilting shelf system of claim 12, wherein said biasing member is extendable and retractable along its longitudinal axis.

14. An adjustable shelf system for a support structure, said adjustable shelf system comprising:
a shelf configured to be coupled to the support structure, and comprising a rear side located opposite a front side, and a first side located opposite a second side, wherein said shelf is tiltable between a horizontal orientation in which said front and rear sides are at the same height, and a tilted orientation in which said front side is below said rear side;
a biasing member coupled to said shelf and configured to bias said front side to the horizontal orientation;
a first handle coupled to said shelf and movable between locked and unlocked positions; and
a first securing member coupled to said shelf, and movable between secured and unsecured positions in response to movement of said first handle between said locked and unlocked positions;
wherein said front side of said shelf is secured against movement relative to said rear side of said shelf while said first securing member is in said secured position; and
wherein said front side of said shelf is vertically adjustable relative to said rear side of said shelf when said first securing member is in said unsecured position.

15. The adjustable shelf system of claim 14, further comprising a second handle and a second securing member coupled to said shelf, wherein said second handle and said second securing member are actuatable independently of said first handle and said first securing member, and wherein said front side of said shelf is vertically adjustable only when both said first and second securing members are in said unsecured positions.

16. The adjustable shelf system of claim 14, further comprising:
an arcuate wear plate disposed along the support structure; and
a pair of ramp stops disposed along said arcuate wear plate;
wherein said first securing member comprises a distal end that engages said wear plate when said front side of said shelf is vertically adjusted; and
wherein said ramp stops urge said first securing member away from said arcuate wear plate as said distal end traverses said ramp stops.

17. The adjustable shelf system of claim 16, further comprising a retention feature proximate said arcuate wear plate at each of said ramp stops, wherein said ramp stops are configured to urge said first securing member away from said arcuate wear plate as said securing member approaches said retention features.

18. An adjustable support system for a support structure, said adjustable support system comprising:
a support surface configured to be pivotably coupled to the support structure;
a securing member coupled to said support surface, and movable between secured and unsecured positions;
a side plate configured for coupling to the support structure and having a retention feature; and
a biasing member coupled to said side plate and to said support surface, wherein said biasing member is configured to urge said support surface upwardly;
wherein said securing member is in said secured position when said securing member is engaged with said retention feature, and said securing member is in said unsecured position when said securing member is disengaged from said retention feature;
wherein said support surface is immobile relative to the support structure while said securing member is in said secured position; and
wherein said support surface is movable relative to the support structure while said securing member is in said unsecured position.

19. The adjustable support system of claim 18, further comprising a handle coupled to said support surface and movable between locked and unlocked positions, said securing member movable between said secured and unsecured positions in response to movement of said handle between said locked and unlocked positions.

20. The adjustable support system of claim 19, further comprising:
an arcuate wear plate disposed along said side plate; and
an intermediate ramp stop and a lower ramp stop disposed along said arcuate wear plate;
wherein said side plate defines a horizontal position hole proximate an upper end of said wear plate, a tilted position hole proximate said lower ramp stop and a lower end of said wear plate, and an intermediate position hole proximate said intermediate ramps stop and a middle region of said wear plate;
wherein said first securing member comprises a distal end that engages and traverses said wear plate when said front side of said shelf is vertically adjusted; and
wherein said ramp stops urge said first securing member away from said arcuate wear plate as said distal end traverses said ramp stops and approaches said intermediate and tilted position holes.
